(19) United States
(12) Patent Application Publication
(10) Pub. No.: US 2003/0074258 A1
(43) Pub. Date: Apr. 17, 2003

(54) Profitable information management system and method thereof

(76) Inventor: Jizhi Pan, Mountain View, CA (US)

Correspondence Address: Otto O. Lee, Esq., Intellectual Property Law Group LLP, 12th Floor, 12 South First Street, San Jose, CA, 95051, US

(21) Appl. No.: 09/977,590

(22) Filed: Oct. 12, 2001

(51) Int. Cl. G06F 17/60

(52) U.S. Cl. 705/14

(57) ABSTRACT

A profitable information management system and method for soliciting and publishing classified advertisements offering a reward (CORs) and related services are disclosed. The CORs include, but are not limited to, promises to pay a reward amount specified by an advertiser to anyone who performs conditions named in the advertisement, and anyone who performs the conditions as a solver to the satisfaction of the advertiser receives the reward amount from the advertiser.

### BACKGROUND

This invention relates to a system and method for fulfilling an advertiser's advertised request. In particular, this is a computer implemented system and method for providing a platform that is accessible by an unlimited number of members of the computer network community, which allows an advertiser to publish a classified advertisement, offering a specified reward to be paid to a solver, solutionist or matchmaker who satisfies the advertiser's advertised request.

Classified newspapers or advertisements exist where an advertiser may publish an advertisement and a solver fulfills the advertisement. The classified newspapers or advertisements, however, are not effective because there is no reward that is necessarily promised by the advertiser to be paid to the solver, and the advertisements are usually limited to specific categories. Also, the number of prospective solvers that are reached by the classified newspapers or advertisements are limited by the geographic and physical distribution of such publications.

In auctions, one party tries to sell an item or service through a third party, and the highest bidder willing to purchase the item or service receives the item or service in exchange for the bid amount. An auction, however, has shortcomings because the bidder may be able to purchase the item or service in question only if the amount he bid is higher than anybody else's bid.

In an Internet intermediary example for fulfilling an advertiser's advertised request, one party acts as an agent for a customer in obtaining an item such as a plane ticket, or a service, for a price specified by the customer. If the agent can fulfill the requirement, the customer makes a payment, receives the item, and the agent receives compensation such as a kickback. This example, however, is not desirable as there is no direct communication between the customer and the provider of the item or service, and the customer does not have the choice to select the provider. The selection of the provider is made solely by the agent, and the customer is obligated to pay the provider chosen by the agent as long as the customer's initial purchase specification is met.

Another example for fulfilling an advertiser's advertised request exists where one party posts information on the Internet and another party fulfills the need with open negotiations between both parties, such as on an online bulletin board or in a chat room. This example is also not desirable, as the types of advertised requests may be limited by the predetermined interests of the members of such bulletin board or chatroom, and there may not be a mandatory monetary reward amount to be paid by the advertiser to the solver for completing the advertised request.

### SUMMARY

The computer implemented profitable information (PI) management system and method of the present invention allows publication of classified advertisements offering a reward (CORs). It opens the market for services and advertisements to unlimited categories and objectives, and it gathers virtually an unlimited number of advertisers present on a computer network, such as the World Wide Web. This invention allows advertisers and solvers to make contact with one another through a reward advertisement scheme where rewards are paid directly to the solvers.

The present invention is an Internet-based system and method that allows anybody access to CORs. The PI management system and method allows advertisers to market their proposals on-line to whomever wanting to complete the project in exchange for the reward amount. Any person, group, or organization can satisfy the advertiser's advertised request, and anyone who fulfills the advertiser's advertised request, accepts the offers. The CORs may advertise any kind of demand, including, but not limited to, information searches, specific industry demands, or personal requests. The reward amount can be any form of monetary compensation. Reverse CORs are classified advertisements that specify the conditions that the advertisers are willing to fulfill in return for a reward. This is a subcategory of CORs.

### DESCRIPTION OF DRAWINGS

FIG. 1 is a schematic diagram showing one embodiment of the profitable information (PI) management system of the present invention, and the interaction of the advertiser submitting a classified advertisement offering a reward (COR) and a number of prospective solvers therewith.

FIG. 2 is a schematic diagram illustrating that at any given time, a number of prospective solvers may be attempting to complete the advertiser's advertised request.

FIG. 3 is a conceptual diagram illustrating a relationship between the advertiser and the solver, whereupon completion of the advertised request by the solver, the advertiser must pay a predefined reward amount to the solver.

FIG. 4 is a schematic diagram of one embodiment of the PI central server of the present invention.

FIG. 5 is a flowchart illustrating one embodiment of the COR management program of the present invention.

FIG. 6 is a flowchart illustrating one embodiment of the COR without contact information publishing program of the present invention.

FIG. 7 is a flowchart illustrating one embodiment of the COR with contact information publishing program of the present invention.

FIG. 8 is a flowchart illustrating one embodiment of the COR contact info retrieval program of the present invention.

FIG. 9 is a flowchart illustrating one embodiment of the service fee program of the present invention.

FIG. 10 is a computer screenshot illustrating one embodiment of the PI broadcast platform of the present invention.

FIG. 11 is a computer screenshot illustrating one embodiment of the PI broadcast platform of the present invention having a COR Submit section.

FIG. 12 is a computer screenshot illustrating one embodiment of the PI broadcast platform of the present invention having a member Sign Up section.

FIG. 13 is a computer screenshot illustrating one embodiment of the PI broadcast platform of the present invention having a member Log In section.

FIG. 14 is a computer screenshot illustrating one embodiment of the PI broadcast platform of the present invention having a COR Contact Inquiry section.

FIG. 15 is a computer screenshot illustrating one embodiment of the PI broadcast platform of the present invention having a COR Recall section for removing a COR from the PI broadcast platform.

FIG. 16 is a computer screenshot illustrating one embodiment of the PI broadcast platform of the present invention having a Subscribe section.

### DETAILED DESCRIPTION

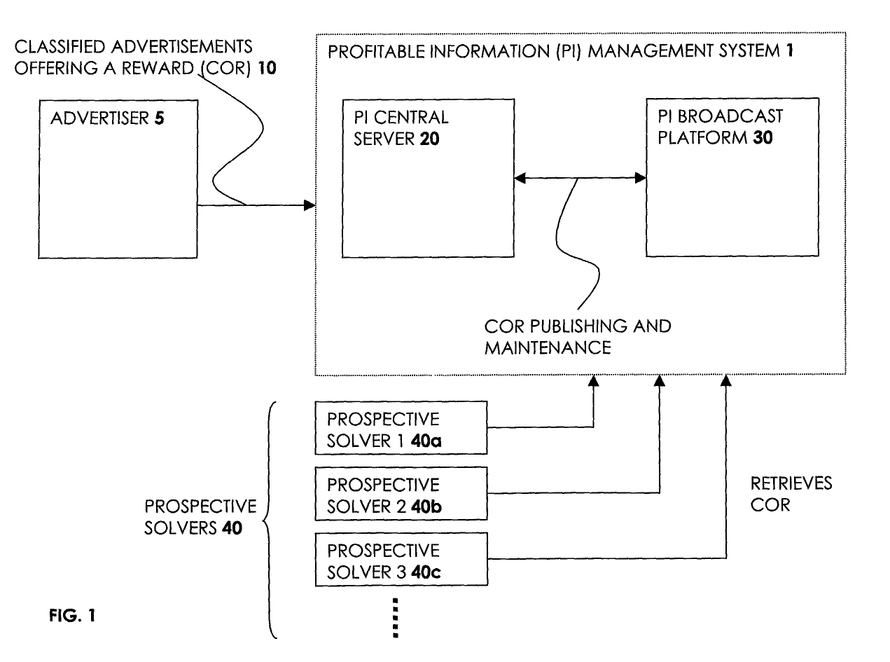

FIG. 1 illustrates a general schematic diagram of the profitable information (PI) management system 1 of the present invention. The PI management system 1 comprises a PI central server 20 and a PI broadcast platform 30, where the PI management system 1 and its components may be located on a publicly available computer network, such as the World Wide Web on the Internet. In one embodiment, PI broadcast platform 30 may be accessible from a web browser.

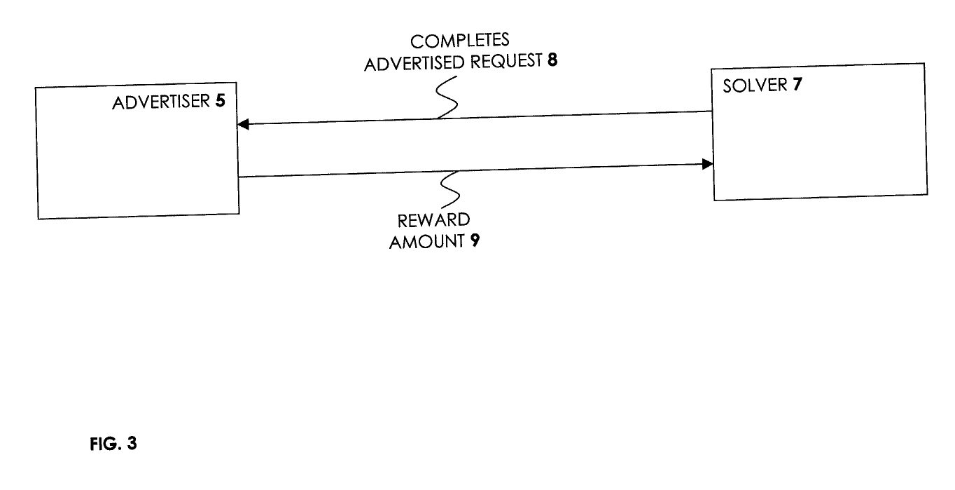

The PI management system 1 allows advertisers 5 to submit classified advertisements offering a reward (CORs) 10. The COR 10 is an advertisement submitted by an advertiser 5 with a promise to pay a reward amount 9 specified by the advertiser to a solver 7 who performs an advertised request 8, i.e., one or more conditions specified by the advertiser 5. See FIG. 3.

CORs 10 are published on the PI broadcast platform 30 for review by prospective solvers 40.

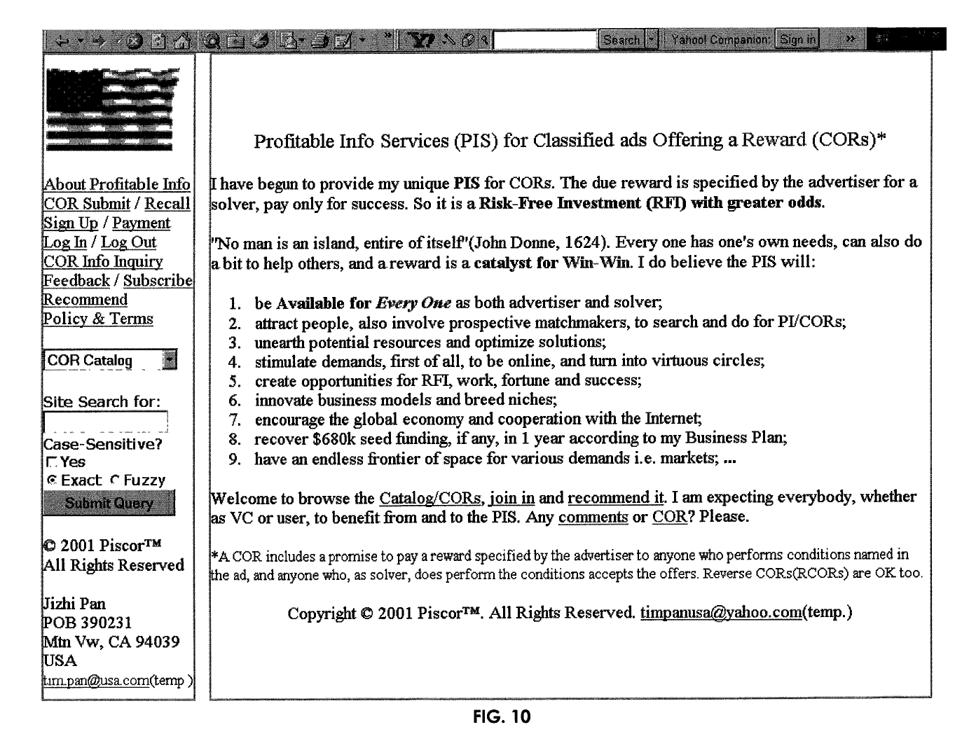

FIG. 10 shows a computer screenshot of the homepage of a website containing one embodiment of the PI management system 1. Advertisers 5 may submit CORs 10 by following a hyperlink to the COR Submit screen shown in the left navigation frame. Prospective solvers 40 may search or browse the site for CORs 10 of interest.

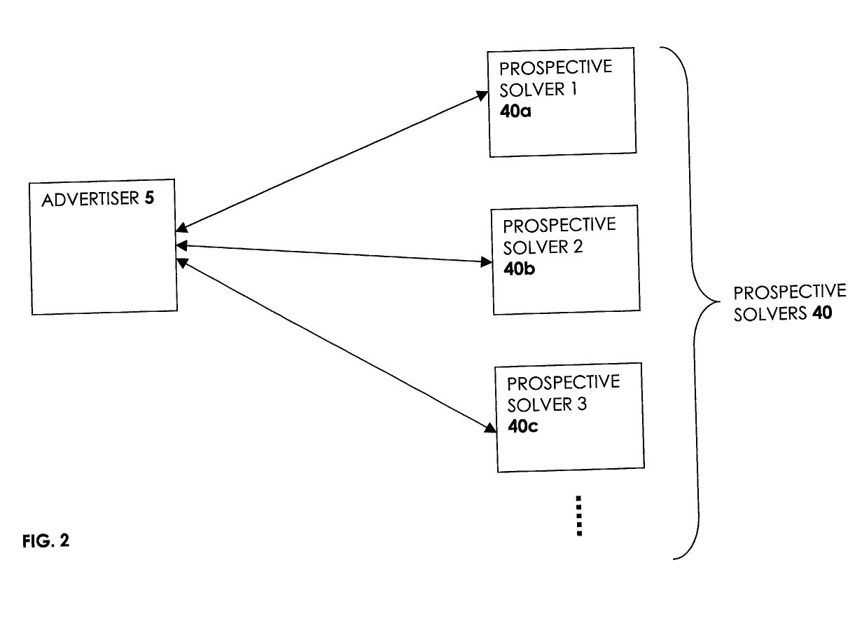

The PI management system 1 of the present invention provides a cyberspace for a vast population of advertisers 5 and prospective solvers 40 from across the World Wide Web community to instantly seek out and communicate with each other. The advertisers 5 solicit fulfillment of a certain advertised request 8 in exchange for a monetary reward amount 9, which will be paid by the advertiser 5 to the solver 7 upon completion of the advertised request 8 to the satisfaction of the advertiser 5 and as mutually agreed upon by the advertiser 5 and the solver 7. See FIG. 3. One advertiser 5 may publish a COR 10 which reaches an unlimited number of prospective solvers 40 simultaneously. FIG. 2 shows an example in which prospective solver 1 40a, prospective solver 2 40b, and prospective solver 3 40c correspond to the CORs 10 on the PI broadcast platform 30 posted by the advertiser 5 and communicate with the advertiser 5 regarding the particulars of the CORs 10, such as the advertised request 8, the reward amount 9, the time of completion of the request, the method of payment, etc. As illustrated in FIG. 3, whichever prospective solver 40 that first completes the advertised request 8 as specified by the advertiser 5 becomes the solver 7, and the solver 7 is entitled to receive the reward amount 9 in exchange for the services rendered.

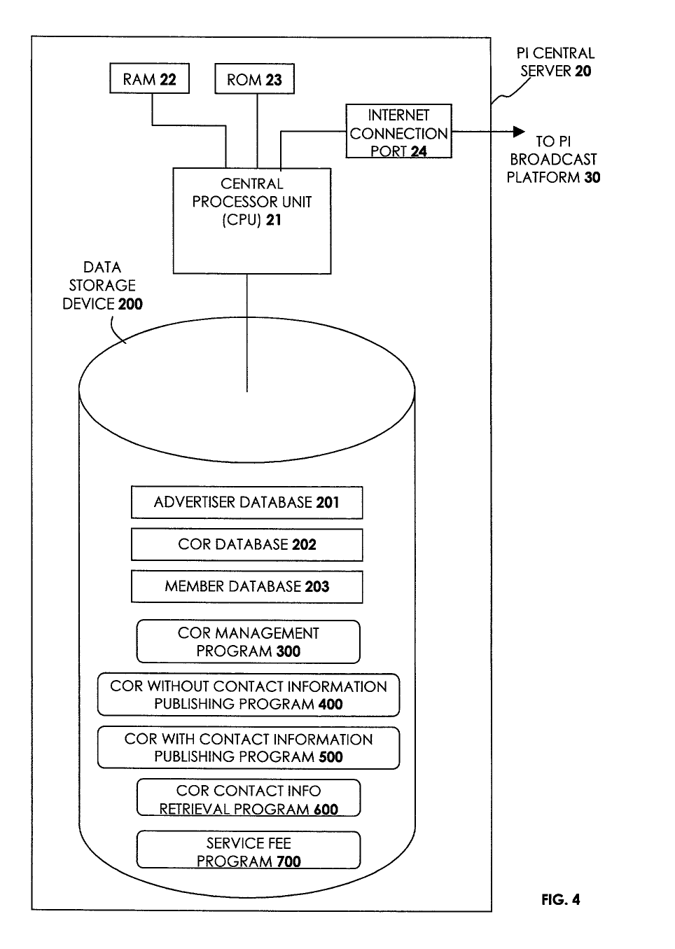

FIG. 4 shows one embodiment of the PI central server 20 of the present invention, which includes a central processor unit (CPU) 21 connected to: a random access memory (RAM) 22, a read-only memory (ROM) 23, an Internet connection port 24, and a data storage device 200. The PI central server 20 is communicably connected to the PI broadcast platform 30 through the Internet connection port 24. The data storage device 200 includes an advertiser database 201, a COR database 202, a member database 203, a COR management program 300, a COR without contact information publishing program 400, a COR with contact information publishing program 500, a COR contact info retrieval program 600, and a service fee program 700. Although the individual contents of the data storage device 200 are depicted within a single object in FIG. 4, it is readily perceivable by those skilled in the art that any one or more of such contents may be physically stored in different locations, and even the individual contents may be broken into parts and stored in different locations.

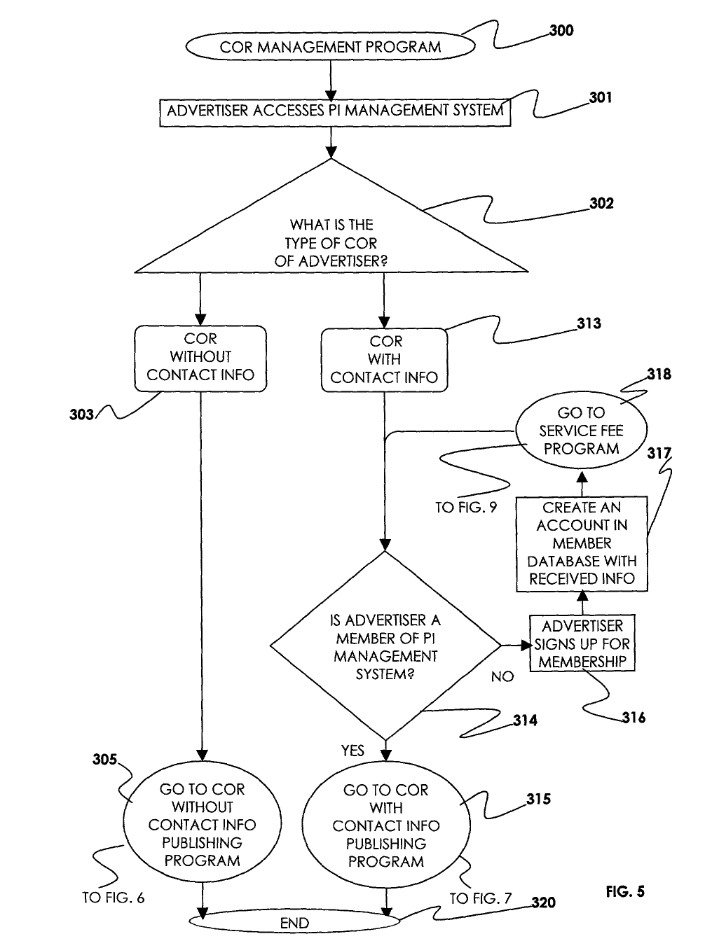

FIG. 5 is a flowchart diagram of the COR management program 300. In step 301, an advertiser 5 accesses the PI management system 1 through the PI broadcast platform 30. The homepage depicted in FIG. 10 is an example of a web page interface between the PI broadcast platform 30 and its users, including the advertisers 5, prospective solvers 40, and solvers 7. In step 302, the advertiser 5 may initiate the COR management program 300 by choosing either A) a COR published without contact information, or, B) a COR published with contact information.

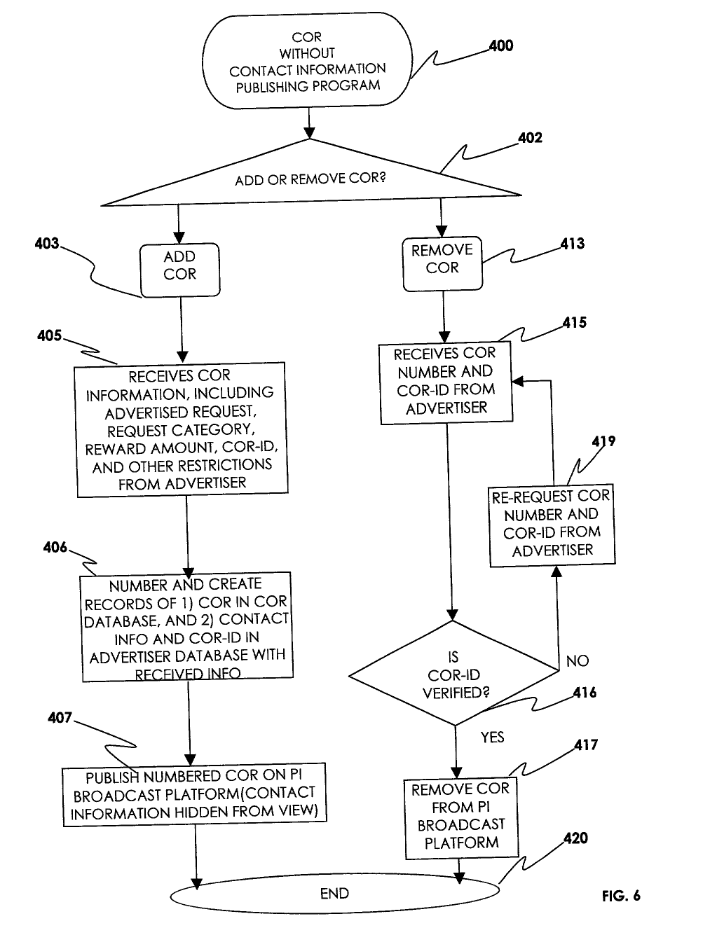

If the advertiser 5 selects the former as in step 303, the PI management system 1 in step 305 further proceeds to COR without contact information publishing program 400, as in FIG. 6.

In step 402, advertiser 5 may further choose 1) add a new COR 10 for publication on the PI broadcast platform 30 by following a hyperlink entitled, “COR Submit”, or 2) remove his own existing COR 10 by following a hyperlink entitled, “Recall”.

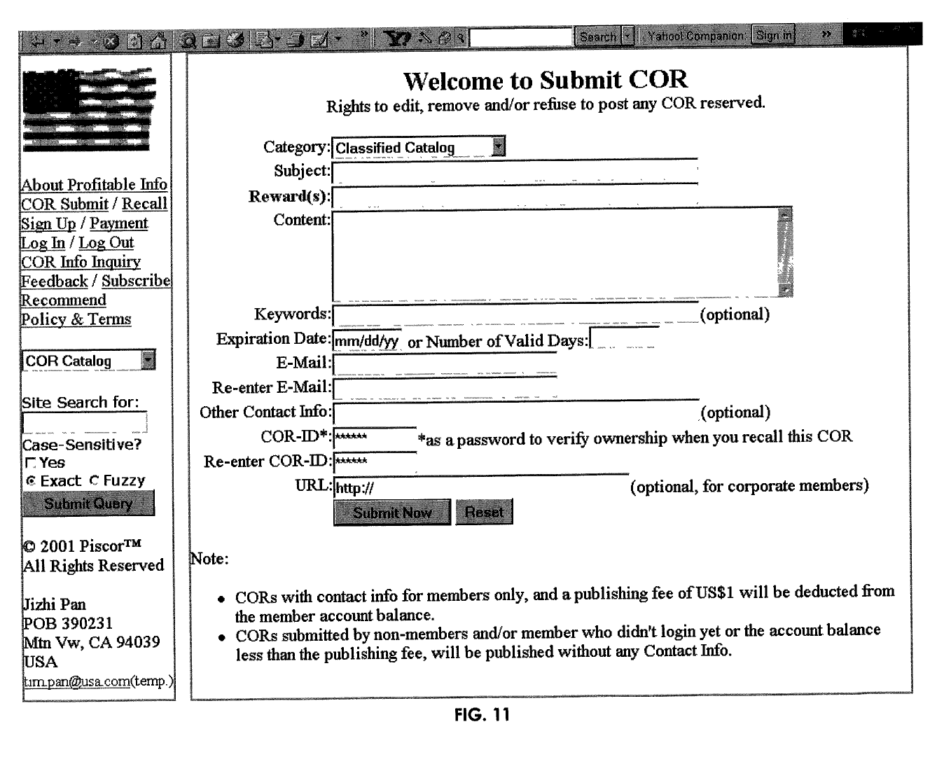

If the advertiser 5 chooses to add a new COR in step 403, and then, in step 405, the PI management system 1 requests advertiser 5 to submit information related to the new COR he wishes to create, including the advertised request 8, the reward amount 9, and the COR-ID for ownership verification, e.g., when it is recalled before expiry. As in FIG. 11, the system 1 may request additional information such as the request category, the expiration date of the COR or the number of days that the COR would be valid, the advertiser's contact information such as e-mail address, and a URL address to the advertiser's website. Some or all of the additional information may be optional in one embodiment.

After the PI management system 1 receives the COR information requested in step 405, the system 1 in step 406 numbers and creates records of 1) the COR in the COR database 202 and 2) of the advertiser's contact information and the COR-ID in the advertiser database 201 according to the COR information, and then proceeds to step 407 to publish the numbered COR 10 on the PI broadcast platform 30, albeit the contact information related to the COR 10 is hidden from view by anybody browsing the COR 10 on the PI broadcast platform 30. The program 400 ends in step 420.

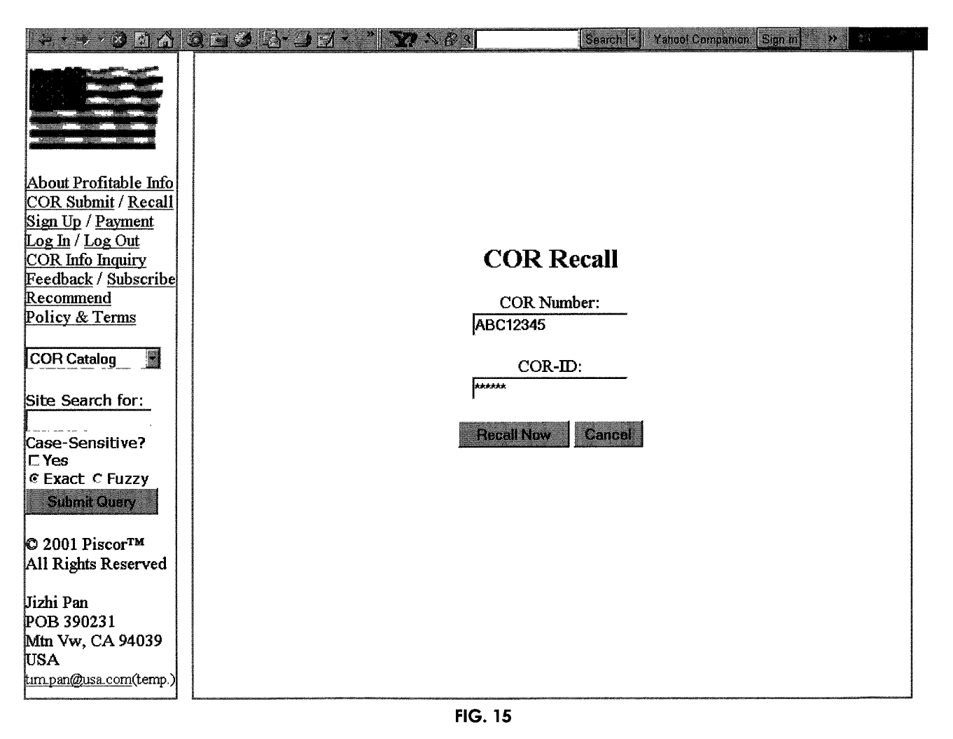

If the advertiser 5 chooses to remove a COR as in step 413, in one embodiment, the advertiser 5 is directed to a new web page as in FIG. 15. Here, the PI management system 1 prompts the advertiser 5 to enter information related to the COR 10 to be removed in question, such as the COR number and the COR-ID, as in step 415. The PI management system 1 then verifies in step 416 whether the COR-ID received from the advertiser 5 corresponds with the value stored in the advertiser database 201.

If the COR-ID is not verified, then the PI management system 1 requests the advertiser 5 to submit the COR number and COR-ID again in step 419. The advertiser 5 may be given a limited number of attempts to enter the COR number and the COR-ID for security purposes, such that if the advertiser 5 fails to provide the matched COR number and COR-ID within the limit, he would be locked out from attempting to remove the COR until the ownership is verified in another way, or, the COR will be removed by the COR without contact information publishing program 400 of the system 1 on the expiration date automatically.

If the COR-ID is successfully verified, then the COR without contact information publishing program 400 of the PI management system 1 removes the COR 10 in question from the PI broadcast platform 30, as in step 417, and the program 400 ends in step 420.

If, instead, the advertiser 5 selects the latter, i.e., a COR published with contact information, the advertiser 5 must be verified as a member of the PI management system 1.

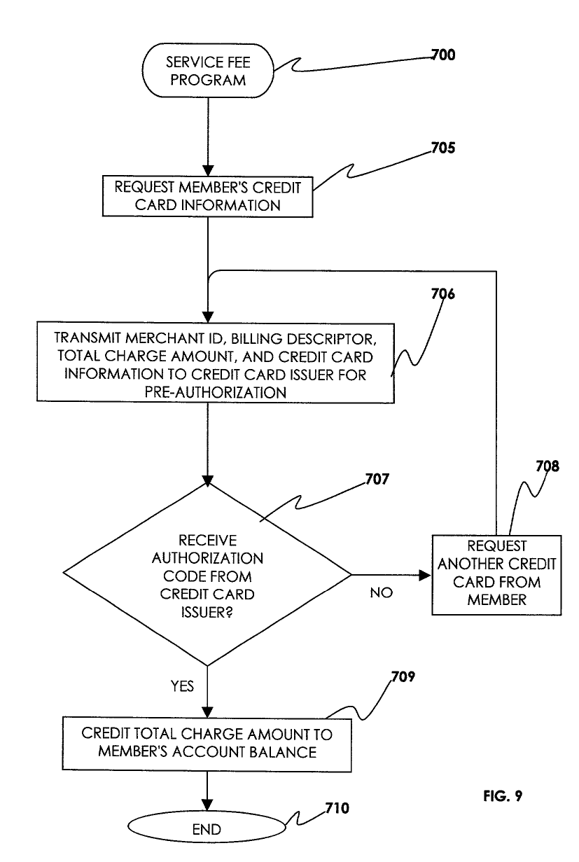

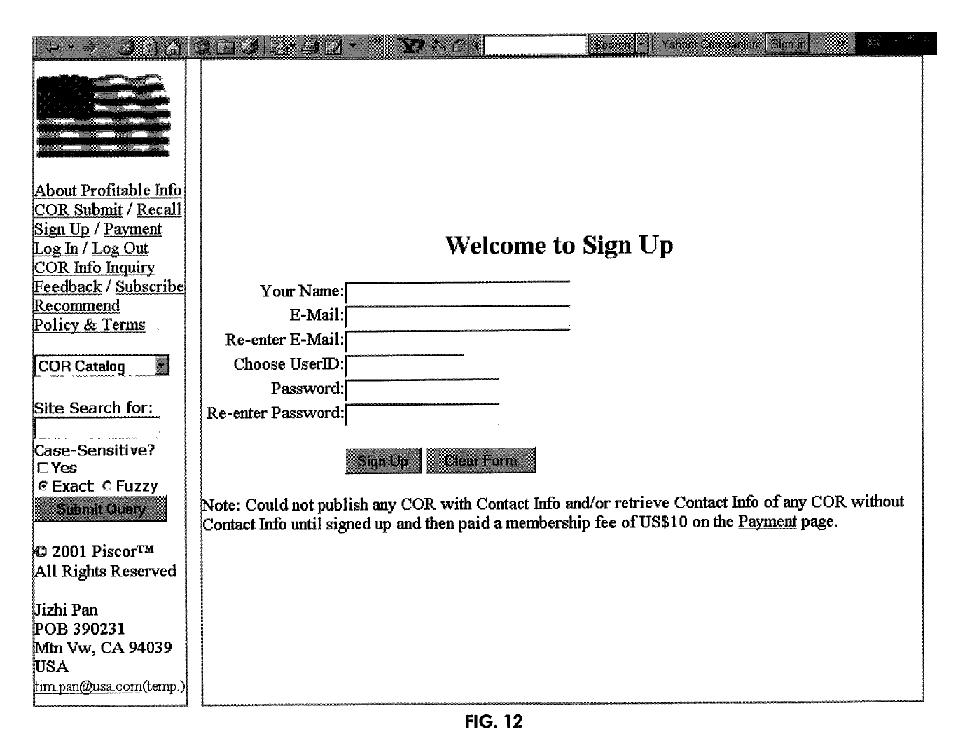

Anybody can access the system 1 through the PI broadcast platform 30. A non-member of the system 1 may sign up to become a member. In one embodiment, the PI broadcast platform 30 includes a hyperlink to the Sign Up area, which allows non-members to sign up to become a member as in FIG. 12. Here, the non-member provides his name and email address to the system 1 as in step 316. The non-member further chooses his own user ID and password for accessing benefits for members of the system 1. The system 1 in step 317 creates a member account in the member database 203 according to received information, the non-member becomes a member of the PI management system 1, but the account balance is zero. Then the system 1 in step 318 further proceeds to the service fee program 700, as in FIG. 9. The service fee program 700 in step 705 requests the member's credit card information, and after successfully charging the member's credit card and crediting the member's account balance with a membership fee, predetermined by the system 1 as shown and described in steps 706-709, the PI management system 1 returns to the COR management program 300.

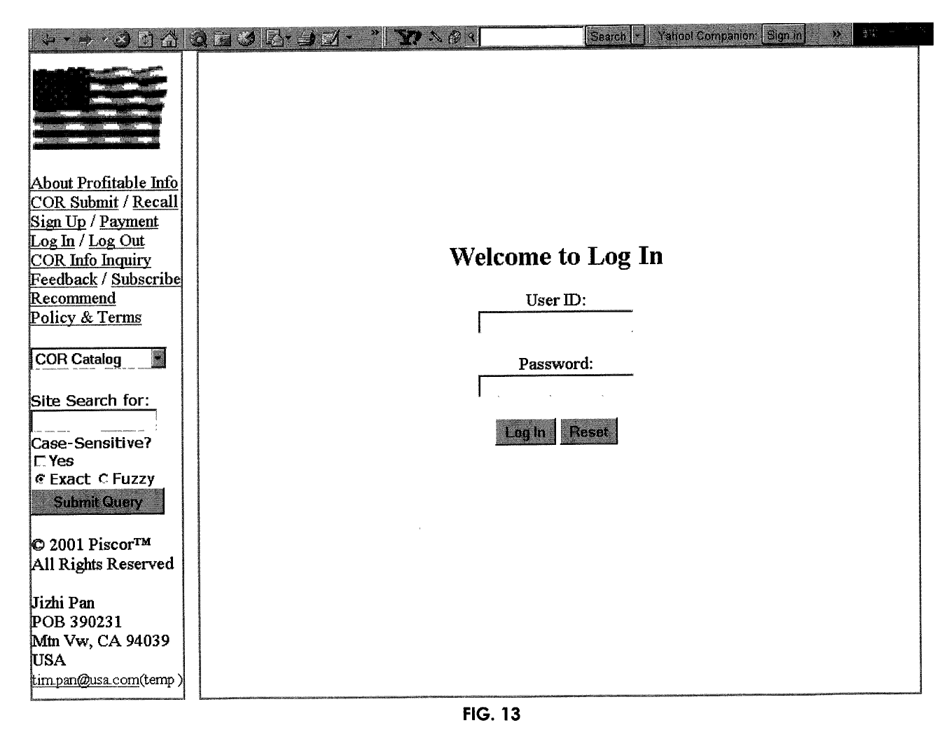

In one embodiment, in step 314, the advertiser 5 is authenticated as a member by the PI management system 1 by logging into his own account in the member database 203 of the system 1 using a user ID and a password through a member Log In screen as in FIG. 13.

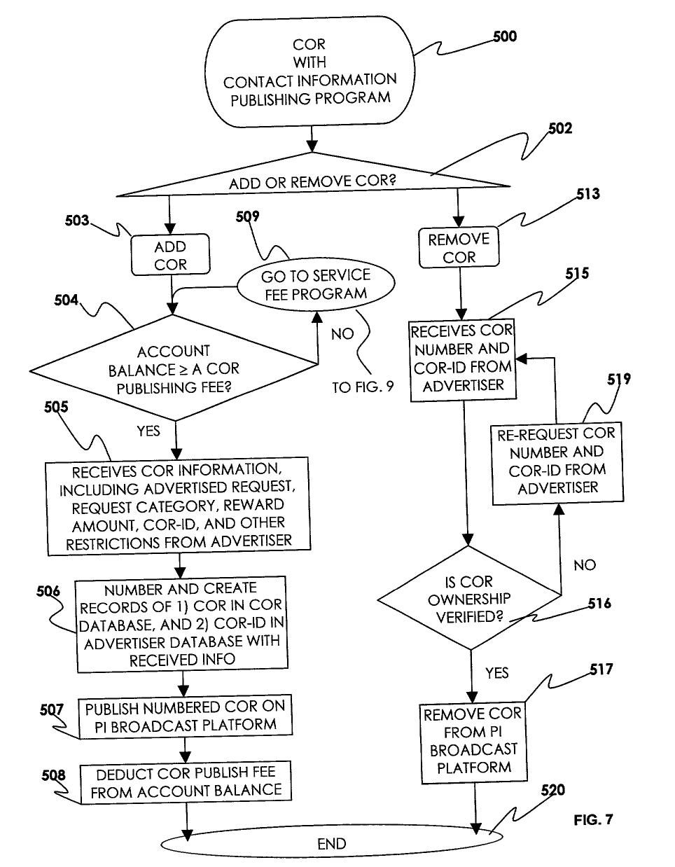

The COR management program 300 continues in step 315 and proceeds to the COR with contact information publishing program 500, as in FIG. 7. In step 502, the advertiser 5 may further choose to 1) add a new COR 10 for publication on the PI broadcast platform 30 by following a hyperlink entitled, “COR Submit”, or 2) remove his own existing COR 10 by following a hyperlink entitled, “Recall”.

If the advertiser 5 selects to add a new COR 10 as in step 503, the COR with contact information publishing program 500 of the PI management system 1 next determines in step 504 whether the advertiser 5's account balance in the member database 203 is at least the same as the COR with contact information publishing fee, as predetermined by the PI management system 1.

If the advertiser 5's account balance is less than the prescribed COR publishing fee, the system 1 proceeds to step 509, the service fee program 700, as in FIG. 9. In one example, the system 1 prompts the advertiser 5 to open the payment page by following the hyperlink on the left navigation frame called Payment. The service fee program 700 in step 705 requests the advertiser 5's credit card information, and after successfully charging the advertiser's credit card and crediting the advertiser's account balance with a COR publishing quota fee predetermined by the system 1 as shown and described in steps 706-709, the PI management system 1 returns to the COR with contact information publishing program 500.

Futher, in step 505, the PI management system 1 requests advertiser 5 to submit information related to the new COR he wishes to create, including the advertised request 8, the reward amount 9, and the COR-ID. As in FIG. 11, the system 1 may request additional information such as the request category, the expiration date of the COR or the number of days that the COR would be valid, the advertiser's contact information such as e-mail address, and a URL address to the advertiser's website. Some or all of the additional information may be optional in one embodiment.

After the PI management system 1 receives the COR information requested in step 505, the system 1 in step 506 numbers and creates records of the COR in the COR database 202, and of the COR-ID in the advertiser database 201 according to the COR information, and proceeds to step 507 to publish the numbered COR 10 with contact information on the PI broadcast platform. The COR publish fee is then deducted from the advertiser's account balance as in step 508, and the program 500 ends in step 520.

If the advertiser 5 chooses to remove a COR as in step 513, in one embodiment, the advertiser is directed to a new web page as in FIG. 15. Here, the PI management system 1 prompts the advertiser 5 to enter information related to the COR 10 to be removed in question, such as the COR number and the COR-ID, as in step 515. The PI management system 1 then verifies the ownership in step 516. The system 1 also verifies whether the COR number, COR-ID and member account information received from the advertiser 5 corresponds with the value stored in the advertiser database 201, the COR database 202 and the member database 203.

If the ownership is not verified, then the PI management system 1 requests the advertiser 5 to submit the COR number and COR-ID again in step 519. The advertiser 5 may be given a limited number of attempts to enter the COR number and the COR-ID for security purposes, such that if the advertiser 5 fails to provide the matched COR number and COR-ID within the limit, he would be locked out from attempting to remove the COR until the ownership is verified in another way, or, the COR will be removed by the COR with contact information publishing program 500 of the system 1 on the expiration date automatically.

If the ownership is successfully verified, then the COR with contact information publishing program 500 of the PI management system 1 removes the COR 10 in question from the PI broadcast platform 30, as in step 517, and the program 500 ends in step 520.

All CORs 10 are open to the public on the PI broadcast platform 30. Anyone, non-member and member of the PI management system 1 alike, can browse or search CORs 10 with or without contact information on the platform 30. A prospective solver of a COR with contact information can directly contact the advertisers for solution and rewards; no further actions in the system 1 are necessary.

To retrieve contact information of a COR 10 without contact information, the retriever must be verified as a member of the PI management system 1.

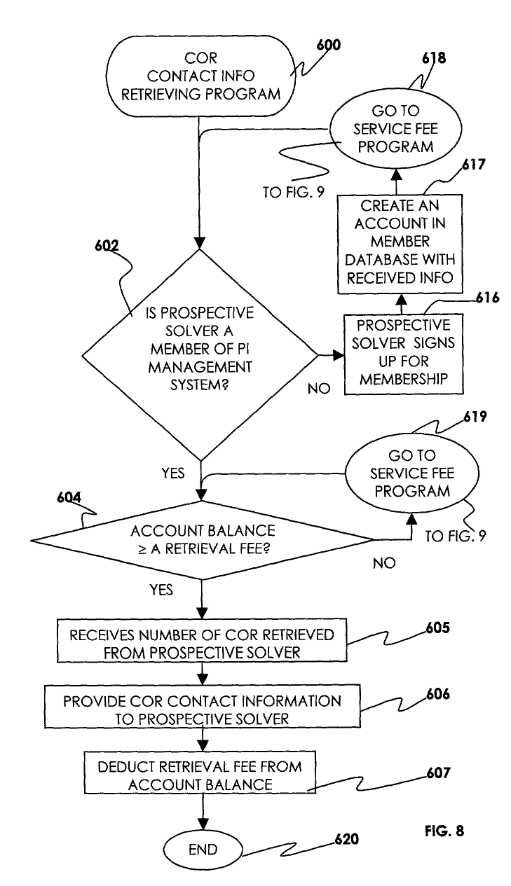

FIG. 8 is a flowchart diagram showing the COR contact info retrieval program 600. The PI management system 1 charges the prospective solver 1 40a a predetermined COR contract info retrieval fee when the prospective solver 1 40a wishes to obtain the advertiser 5's contact information corresponding to COR 10 without contact information.

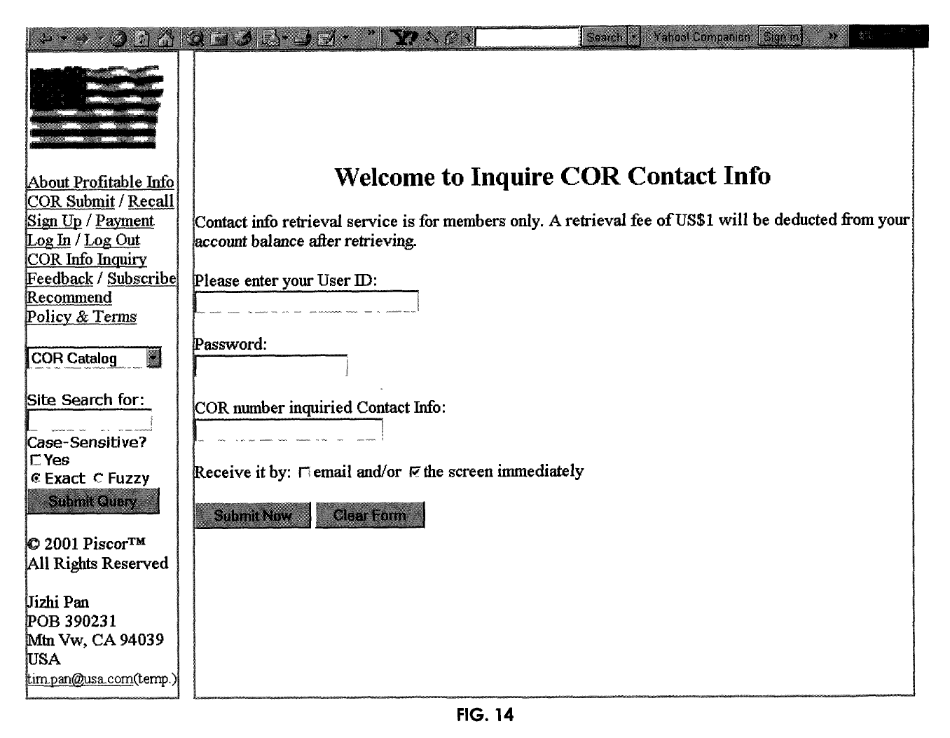

In one embodiment, in step 602, the prospective solver 1 40a is authenticated as a member by the PI management system 1 by logging into his own account in the system 1 using a user ID and a password through a COR contact information retrieval screen as in FIG. 14. The user ID and the password are initially selected by the member when he signs up to the system 1. By providing the correct user ID and the password, the prospective solver 1 40a is successfully logged into his own account in the member database 203 of the system 1 to retrieve the COR contact information in question. If the prospective solver 1 40a is not yet a member of the PI management system 1, then in step 616, the prospective solver 1 40a signs up as a member and pay the membership fee, as described in paragraph [0039] above.

The COR contact info retrieval program 600 of the PI management system 1 next determines in step 604 whether the prospective solver 1 40a's account balance is at least the same as the COR contact info retrieval fee, as predetermined by the PI management system 1.

If the prospective solver 1 40a's account balance is less than the prescribed COR contact info retrieval fee, the system 1 proceeds to step 619, the service fee program 700, as in FIG. 9. In one example, the system 1 prompts the advertiser 5 to open the payment page by following the hyperlink on the left navigation frame called Payment. The service fee program 700 in step 705 requests the prospective solver 1 40a's credit card information, and after successfully charging the prospective solver 1 40a's credit card and crediting the prospective solver 1 40a's account balance with a COR contact info retrieval quota fee predetermined by the system 1 as shown and described in steps 706-709 of FIG. 9, the PI management system 1 returns to the COR contact info retrieval program 600. In one embodiment, in step 605, the system 1 receives the number of the COR retrieved by the prospective solver 1 40a as FIG. 14, and provides the COR 10 contact information to him as in step 606. A COR contact info retrieval fee is then deducted from the prospective solver 1 40a's account balance as in step 607. The program 600 ends in step 620.

One embodiment of the present invention involves a deal method called Do It Yourself (DIY), where the users of the PI management system 1 are responsible for conducting their own negotiations, deals, and transactions amongst themselves. The PI management system 1 will not charge any fee for such self-services.

In another instance, the PI management system 1 provides assistance and value-added services to the users. Such services may relate to escrow, trust, certification, agency, money exchange, transportation of goods, insurance coverage, declaration, translation, B2B2C2C, etc.

In one embodiment, the users may register as corporate or individual members of the PI management system 1.

Non-members are allowed, free of charge and without limit on the broadcast platform 30, to:

1) publish CORs 10 without contact information, and recall them anytime before the customized expiry;

2) browse and search all CORs 10 both with and without contact information;

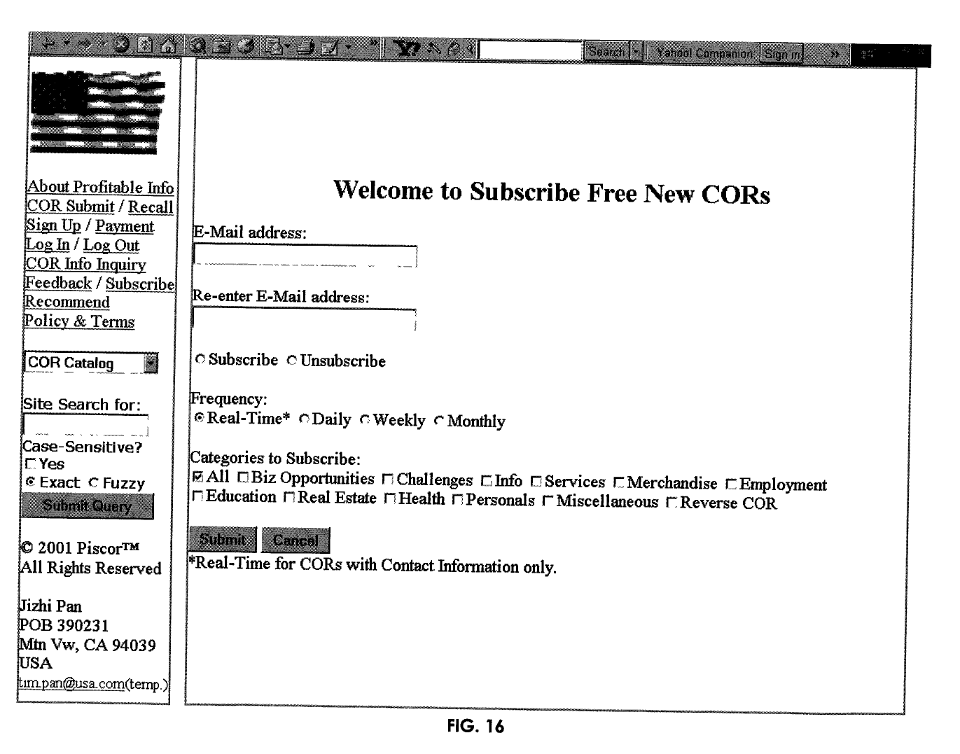

3) subscribe to custom e-newsletters, up-to-date and/or real-time CORs 10 (see FIG. 16);

4) fill in addresses to send recommendation emails with default and editable content to friends; and

5) access, read, and write guest books and forums for various topics.

The additional benefits of becoming a paid member is that the member is allowed to log in, to:

1) allow COR 10 with contact information publishing based on quota, where the quota is counted as a number and published time period of COR 10 advertisements;

2) allow COR 10 contact information inquiries based on quota; and

3) pay a fee for more quota.

Corporate members are further allowed to add their URL or advertisement hyperlink on the PI broadcast platform 30 to generate traffic to their business.

What is claimed is:

1. A computer implemented profitable information (PI) management system for advertisers to post a plurality of classified advertisements offering a reward (CORs) to be completed by solvers, comprising:
a. a PI broadcast platform, and
b. a PI central server communicably connected to the PI broadcast platform, said PI central server being configured to:
i. receive one or more CORs from one or more advertisers, each COR including:
1. an advertised request,
2. a reward amount, and
3. a classified advertisement offering a reward identification (COR-ID); and
ii. receive a set of contact information from each of the advertisers; and
iii. publish the CORs on the PI broadcast platform.

2. The system of claim 1, wherein the CORs are viewable by one or more prospective solvers on the PI broadcast platform.

3. The system of claim 2, wherein the reward amount must be paid by the advertiser to a solver upon completion of the advertised request by the solver.

4. The system of claim 3, wherein the solver is the prospective solver who first completes the advertised request to the satisfaction of the advertiser.

5. The system of claim 4, wherein the PI central server further comprises one or more data storage devices for storing the CORs and the advertisers' contact information.

6. The system of claim 5, wherein the data storage devices further comprise:
a. an advertiser database for storing the advertisers' contact information and the COR-ID;
b. a COR database for storing information related to the CORs submitted by the advertisers; and
c. a member database for storing all member account information.

7. The system of claim 6, wherein the COR database stores one or more COR numbers, such that each of the COR numbers is related to each of the advertisers' contact information and the COR-ID.

8. The system of claim 7, wherein the data storage devices further comprise:
a. a COR management program;
b. a COR without contact information publishing program;
c. a COR with contact information publishing program;
d. a COR contact info retrieval program; and
e. a service fee program.

9. The system of claim 8, wherein the COR management program is configured to allow the advertisers to publish a COR with contact information or a COR without contact information.

10. The system of claim 8, wherein the COR without contact information publishing program is configured to allow an advertiser to submit the CORs and publish them without contact information on the PI broadcast platform, and to remove them anytime before its expiration date.

11. The system of claim 8, wherein the COR with contact information publishing program is configured to allow any member of the PI management system, as an advertiser, to submit the CORs and publish them with contact information on the PI broadcast platform, and to remove them anytime before its expiration date.

12. The system of claim 11, wherein the PI management system publishes the COR submitted by the member, if and only if an account balance of the member is at least equal to a COR with contact information publish fee, predetermined by the PI management system.

13. The system of claim 9, wherein the COR contact info retrieval program is configured to allow a member of the PI management system to obtain the advertiser's contact information related to the COR without contact information, selected by the member.

14. The system of claim 13, wherein the PI management system provides the advertiser's contact information to the member if and only if an account balance of the member is at least equal to a COR contact information retrieval fee predetermined by the PI management system.

15. The system of claim 8, wherein the service fee program is configured to allow one or more new members to pay a membership fee, or to allow the advertisers to increase their account balances by an amount equal to or greater than a COR with contact information publish fee, or to allow the prospective solvers to increase their account balances by an amount equal to or greater than a COR contact information retrieval fee, wherein the amount of the COR with contact information publish fee and the amount of the COR contact information retrieval fee, predetermined by the PI management system.

16. A computer implemented profitable information (PI) management method, comprising:
a. receiving, by a profitable information management system, a classified advertisement offering a reward (COR) from an advertiser, the COR including:
i. an advertised request,
ii. a reward amount, and
iii. a classified advertisement offering a reward identification (COR-ID); and
b. receiving by the PI management system a set of contact information from each of the advertisers;
c. publishing the COR on a PI broadcast platform; and
d. displaying the COR to one or more prospective solvers.

17. The method of claim 16, wherein the reward amount is paid directly by the advertiser to a solver after the advertised request is fulfilled by the solver.

18. The method of claim 16, wherein the COR is published on the PI management platform without the advertiser's contact information.

19. The method of claim 16, wherein the COR is published on the PI management system with the advertiser's contact information, the method further comprising:
a. verifying whether or not the advertiser is a member of the PI management system; and
b. upon verifying that the advertiser is a member of the PI management system, comparing the advertiser's account balance and a COR publishing fee predetermined by the PI management system,
wherein the publishing step occurs if and only if the account balance is greater than or equal to the COR publishing fee.

20. The method of claim 18 further comprising:
a. requesting by a prospective solver of the advertiser's contact information for a COR selected by the prospective solver;
b. verifying whether or not the prospective solver is a member of the PI management system;
c. upon verifying that the prospective solver is a member of the PI management system, comparing the prospective solver's account balance and a COR contact info retrieval fee predetermined by the PI management system; and
d. providing the advertiser's contact information to the prospective solver if and only if the account balance is greater than or equal to the COR contact info retrieval fee.
